(19) United States
(12) Patent Application Publication
(10) Pub. No.: US 2022/0077524 A1
(43) Pub. Date: Mar. 10, 2022

(54) HEATING DEVICE AND STORAGE DEVICE

(71) Applicant: ROHM Co., Ltd., Kyoto (JP)

(72) Inventors: Shunsuke Akasaka, Kyoto (JP); Yurina Amamoto, Kyoto (JP); Ken Nakahara, Kyoto (JP)

(21) Appl. No.: 17/463,655

(22) Filed: Sep. 1, 2021

(30) Foreign Application Priority Data
Sep. 7, 2020 (JP) 2020-149851

(51) Int. Cl. H01M 10/6571; H05B 3/22; H01M 10/63; H01M 10/615

(52) U.S. Cl. CPC H01M 10/6571; H01M 10/615; H01M 10/63; H05B 3/22

(57) ABSTRACT

Provided are a heating device and a storage device. The heating device includes a board, and a plurality of microheaters arranged on the board and electrically connected to the board. The plurality of microheaters are arranged in a form of an array. Each of the plurality of microheaters includes a first silicon substrate, an insulating film, and a heater. A first opening portion that penetrates the first silicon substrate along a thickness direction is formed in the first silicon substrate. The insulating film includes a central portion on which the heater is disposed, a peripheral portion disposed on the first silicon substrate, and a connecting portion that connects the central portion and the peripheral portion to each other, and supports the central portion on the first opening portion. The storage device includes a battery pack and the above-described heating device. The board is disposed on the battery pack.

### CROSS REFERENCE TO RELATED APPLICATIONS

This application claims priority benefit of Japanese Patent Application No. JP 2020-149851 filed in the Japan Patent Office on Sep. 9, 2020. Each of the above-referenced applications is hereby incorporated herein by reference in its entirety.

### BACKGROUND

The present disclosure relates to a heating device and a storage device.

Japanese Patent Laid-Open No. 2006-286508 (hereinafter, Patent Document 1) describes a charging device. The charging device described in Patent Document 1 includes a battery pack and a temperature adjusting heater.

### SUMMARY

In the charging device described in Patent Document 1, the temperature adjusting heater has a large heat capacity. Therefore, the charging device described in Patent Document 1 has a low heating efficiency, and takes time for heating.

The present disclosure has been made in view of the problems of the existing technology as described above. More specifically, the present disclosure is to provide a heating device that can heat a heating target body efficiently.

A heating device according to an embodiment of the present disclosure includes a board and a plurality of microheaters arranged on the board and electrically connected to the board. The plurality of microheaters are arranged in a form of an array. Each of the plurality of microheaters includes a first silicon substrate, an insulating film, and a heater. A first opening portion that penetrates the first silicon substrate along a thickness direction is formed in the first silicon substrate. The insulating film includes a central portion on which the heater is disposed, a peripheral portion disposed on the first silicon substrate, and a connecting portion that connects the central portion and the peripheral portion to each other, and supports the central portion on the first opening portion.

The above-described heating device may further include a plurality of second silicon substrates. Each of the plurality of second silicon substrates may be disposed between each of the plurality of microheaters and the board.

In the above-described heating device, a via hole that penetrates each of the plurality of second silicon substrates along the thickness direction may be formed in each of the plurality of second silicon substrates. Each of the plurality of second silicon substrates may have a conductor that is disposed within the via hole and electrically connects each of the plurality of microheaters and the board to each other.

In the above-described heating device, a second opening portion that penetrates each of the plurality of second silicon substrates along the thickness direction may be formed in each of the plurality of second silicon substrates. Each of the plurality of second silicon substrates may be disposed such that the second opening portion is superposed on the first opening portion.

In the above-described heating device, a plurality of third opening portions that penetrate the board along the thickness direction may be formed in the board. The board may be disposed such that each of the plurality of third opening portions is superposed on the first opening portion of each of the plurality of microheaters and the second opening portion of each of the plurality of second silicon substrates.

In the above-described heating device, the board may be a flexible printed board. The above-described heating device may further include a controller. The controller may be connected to the plurality of microheaters, and configured to be able to control operation of the heater of each of the plurality of microheaters individually.

A storage device according to an embodiment of the present disclosure includes a battery pack and the above-described heating device. The board is disposed on the battery pack.

The heating device according to the present disclosure can heat a heating target body efficiently. The storage device according to the present disclosure can heat the battery pack efficiently.

### BRIEF DESCRIPTION OF THE DRAWINGS

FIG. 1 is a sectional view of a heating device;

FIG. 2 is a sectional view of a microheater;

FIG. 3 is a plan view of the microheater;

FIG. 4 is a plan view of the heating device;

FIG. 5 is a functional block diagram of the heating device; and

FIG. 6 is a sectional view of a storage device.

### DETAILED DESCRIPTION OF THE PREFERRED EMBODIMENTS

Details of embodiments of the present disclosure will hereinafter be described with reference to the drawings. In the following drawings, identical or corresponding parts are identified by the same reference signs, and repeated description thereof will not be repeated.

### (Configuration of Heating Device According to Embodiment)

A configuration of a heating device according to an embodiment (hereinafter referred to as a “heating device 100”) will be described in the following.

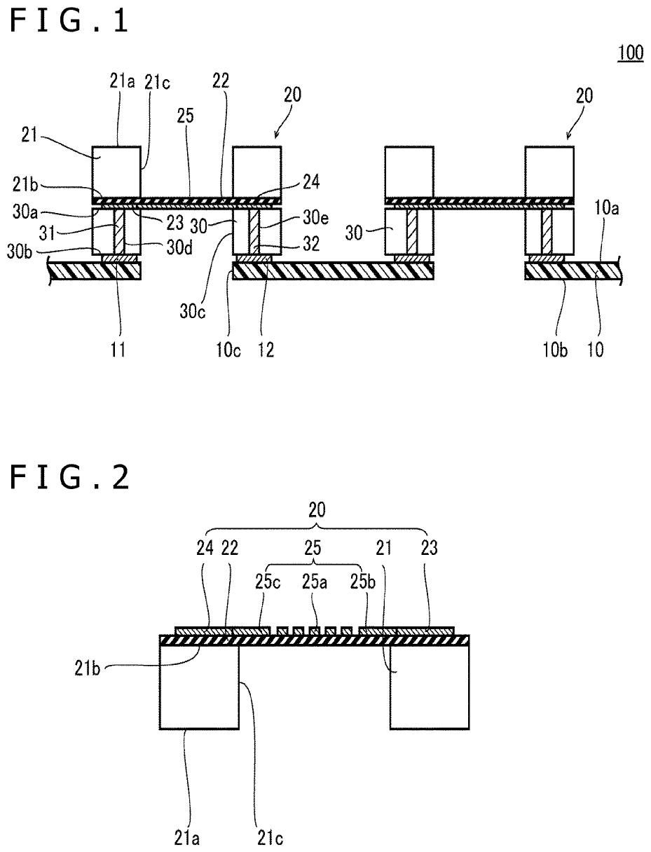

FIG. 1 is a sectional view of the heating device 100. As illustrated in FIG. 1, the heating device 100 includes a board 10, a plurality of microheaters 20, and a plurality of silicon substrates 30.

The board 10 has a principal surface 10a and a principal surface 10b. The principal surface 10b is an opposite surface from the principal surface 10a. The principal surface 10a and the principal surface 10b constitute end surfaces in the thickness direction of the board 10. The board 10 is preferably formed of a flexible material. The board 10 is, for example, formed of polyimide or the like. That is, the board 10 is a flexible printed board. However, the board 10 may not be a flexible printed board. The board 10 may, for example, be a rigid board formed of a resin material containing a reinforcing fiber.

A plurality of opening portions 10c are formed in the board 10. The opening portions 10c penetrate the board 10 along the thickness direction (direction from the principal surface 10a to the principal surface 10b). Though not illustrated, the opening portion 10c, for example, has a rectangular shape as viewed in plan. The board 10 has a pad 11 and a pad 12. The pad 11 and the pad 12 are formed of an electrically conductive material. The electrically conductive material is copper (Cu), for example. The pad 11 and the pad 12 are arranged on the principal surface 10a.

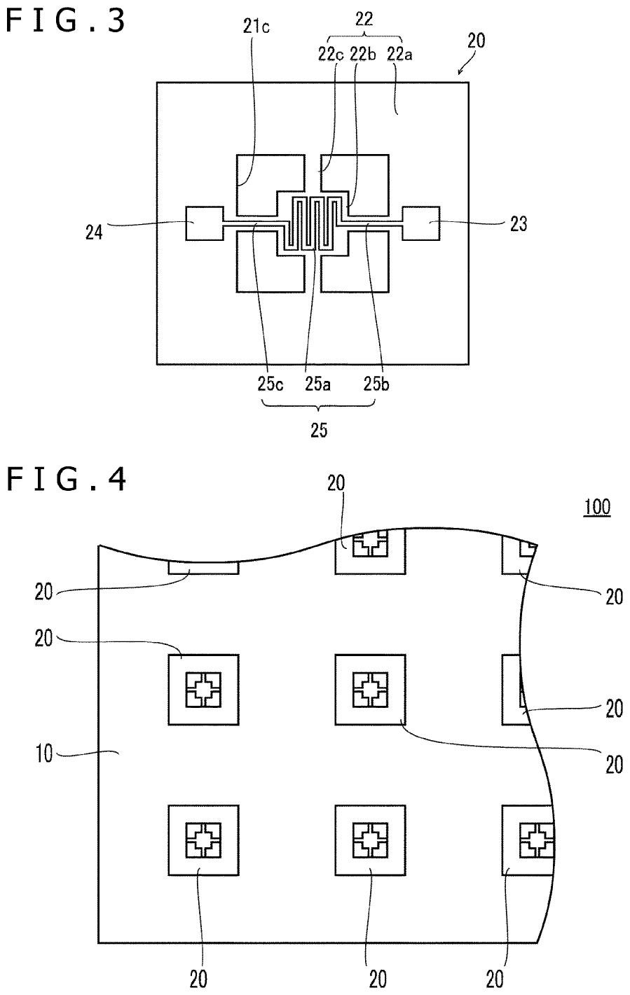

The microheaters 20 are arranged on the board 10. FIG. 2 is a sectional view of a microheater 20. FIG. 3 is a plan view of the microheater 20. As illustrated in FIG. 2 and FIG. 3, the microheater 20 includes a silicon substrate 21, an insulating film 22, a pad 23 and a pad 24, and wiring 25.

The silicon substrate 21 is a substrate formed of silicon (Si). The silicon substrate 21 has a principal surface 21a and a principal surface 21b. The principal surface 21b is an opposite surface from the principal surface 21a. The principal surface 21a and the principal surface 21b constitute end surfaces in the thickness direction of the silicon substrate 21. The microheater 20 is, for example, disposed such that the principal surface 21b faces the board 10 side (see FIG. 1).

An opening portion 21c is formed in the silicon substrate 21. The opening portion 21c penetrates the silicon substrate 21 along the thickness direction (direction from the principal surface 21a to the principal surface 21b). The microheater 20 is disposed such that the opening portion 21c is superposed on the opening portion 10c (see FIG. 1). The opening portion 21c, for example, has a rectangular shape as viewed in plan (see FIG. 3).

The insulating film 22 includes a peripheral portion 22a, a central portion 22b, and a connecting portion 22c. The peripheral portion 22a is disposed on the silicon substrate 21 (on the principal surface 21b). The central portion 22b is disposed on the opening portion 21c. The central portion 22b has a rectangular shape as viewed in plan. The connecting portion 22c connects the peripheral portion 22a and the central portion 22b to each other by extending from each side, as viewed in plan, of the central portion 22b to the peripheral portion 22a. The central portion 22b is thereby supported on the opening portion 21c.

The insulating film 22 is formed of an insulative material. The insulating film 22 is, for example, formed by laminating a film of silicon oxide and a film of silicon nitride.

The pad 23 and the pad 24 are arranged on the insulating film 22. More specifically, the pad 23 and the pad 24 are arranged on the peripheral portion 22a. The wiring 25 includes a heater portion 25a, a connecting portion 25b, and a connecting portion 25c.

The heater portion 25a is disposed on the central portion 22b. The wiring 25 meanders in the heater portion 25a. The connecting portion 25b passes on the connecting portion 22c, and connects the pad 23 and the heater portion 25a to each other. The connecting portion 25c passes on the connecting portion 22c, and connects the pad 24 and the heater portion 25a to each other. The heater portion 25a generates heat when a voltage is applied between the pad 23 and the pad 24 and a current flows through the heater portion 25a. That is, the heater portion 25a is a heater of the microheater 20.

The pad 23, the pad 24, and the wiring 25 are formed of an electrically conductive material. The pad 23, the pad 24, and the wiring 25 are formed integrally with one another. The electrically conductive material is platinum (Pt), for example.

The microheater 20 is formed by the following method. First, the silicon substrate 21 is prepared. Second, the insulating film 22 is formed on the silicon substrate 21 (on the principal surface 21b). The insulating film 22 is formed by film-forming a material constituting the insulating film 22 by, for example, chemical vapor deposition (CVD) or the like, and patterning the film-formed material by photolithography and etching.

Third, the pad 23, the pad 24, and the wiring 25 are formed. The formation of the pad 23, the pad 24, and the wiring 25 is performed by film-forming a material constituting the pad 23, the pad 24, and the wiring 25 by sputtering or the like, and patterning the film-formed material by photolithography and etching.

Fourth, the formation of the opening portion 21c is performed. The opening portion 21c is formed by etching the silicon substrate 21. Thus, the microheater 20 can be formed by using a semiconductor manufacturing process.

FIG. 4 is a plan view of the heating device 100. As illustrated in FIG. 4, the plurality of microheaters 20 are arranged in the form of an array (form of a matrix). The plurality of microheaters 20 are, for example, arranged in the form of a square lattice. However, the array-shaped arrangement of the plurality of microheaters 20 is not limited to this. The plurality of microheaters 20 may, for example, be arranged in the form of a staggered lattice.

The silicon substrates 30 are substrates formed of silicon. As illustrated in FIG. 1, a silicon substrate 30 is disposed between the board 10 and the microheater 20. The silicon substrate 30 has a principal surface 30a and a principal surface 30b. The principal surface 30b is an opposite surface from the principal surface 30a. The principal surface 30a and the principal surface 30b constitute end surfaces of the silicon substrate 30 in the thickness direction. The silicon substrate 30 is disposed such that the principal surface 30a faces the principal surface 21b and the principal surface 30b faces the principal surface 10a.

An opening portion 30c is formed in the silicon substrate 30. The opening portion 30c penetrates the silicon substrate 30 along the thickness direction (direction from the principal surface 30a to the principal surface 30b). The silicon substrate 30 is disposed such that the opening portion 30c is superposed on the opening portion 10c and the opening portion 21c. Though not illustrated, the opening portion 30c, for example, has a rectangular shape as viewed in plan.

A via hole 30d and a via hole 30e are formed in the silicon substrate 30. The via hole 30d and the via hole 30e penetrate the silicon substrate 30 along the thickness direction. The silicon substrate 30 has a conductor 31 and a conductor 32. The conductor 31 and the conductor 32 are respectively arranged (filled) in the via hole 30d and the via hole 30e. The conductor 31 is connected to the pad 11 and the pad 23. The conductor 32 is connected to the pad 12 and the pad 24. Thus, the conductor 31 and the conductor 32 electrically connect the board 10 and the microheater 20 to each other.

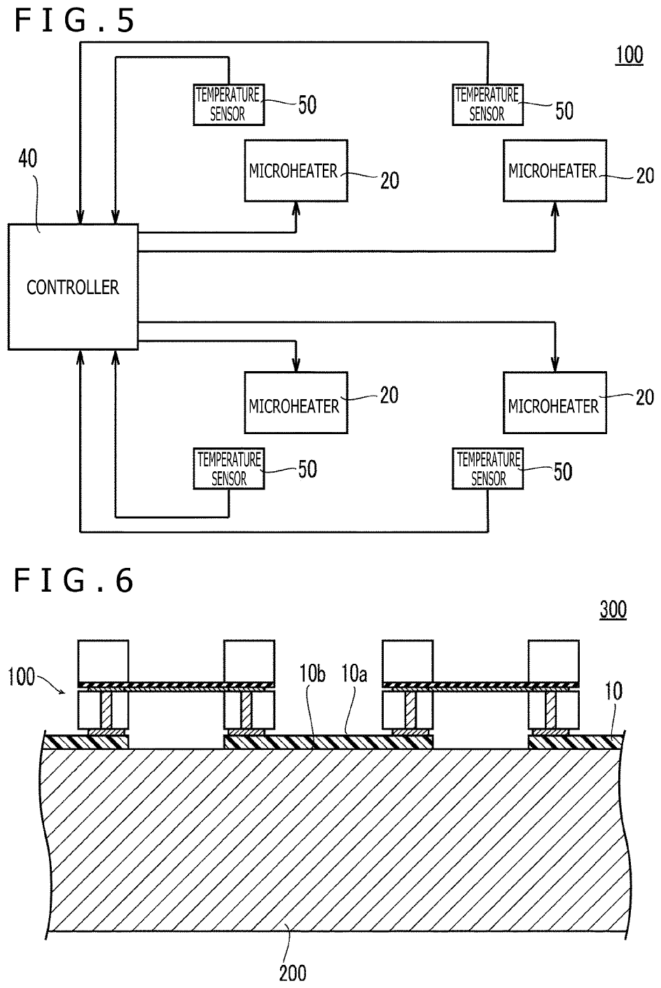

FIG. 5 is a functional block diagram of the heating device 100. As illustrated in FIG. 5, the heating device 100 further includes a controller 40 and a plurality of temperature sensors 50.

The controller 40 is a microcontroller, for example. Though not illustrated in FIG. 1, the controller 40 may be disposed on the board 10, or may not be disposed on the board 10.

Each of the plurality of microheaters 20 is connected to the controller 40. Each of connections between the plurality of microheaters 20 and the controller 40 is independent of the other. Each of the plurality of temperature sensors 50 is connected to the controller 40.

Though not illustrated in FIG. 1, the plurality of temperature sensors 50 are individually disposed on the board 10 (principal surface 10a) so as to be located in the vicinities of the plurality of microheaters 20. Each of connections between the plurality of temperature sensors 50 and the controller 40 is independent of the other. The controller 40 individually controls heating operation of each of the plurality of microheaters 20 on the basis of each of output signals of the plurality of temperature sensors 50.

The plurality of microheaters 20 may be divided into a plurality of groups for respective regions of the board 10. In this case, connections between microheaters 20 belonging to a certain group and the controller 40 are independent of connections between microheaters 20 belonging to another group and the controller 40. In addition, in this case, each of the plurality of temperature sensors 50 is disposed in the respective region of the board 10, and is connected to the controller 40 for the respective region. The controller 40 can thereby control heating operation of the plurality of microheaters 20 for each region of the board 10.

### (Configuration of Storage Device According to Embodiment)

A configuration of a storage device according to an embodiment (hereinafter referred to as a “storage device 300”) will be described in the following.

FIG. 6 is a sectional view of the storage device 300. As illustrated in FIG. 6, the storage device 300 includes the heating device 100 and a battery pack 200. The battery pack 200 is, for example, a battery pack of a lithium (Li) ion secondary battery. Though not illustrated, the battery pack 200 is, for example, included in an apparatus (for example, a smart phone, a power tool, or the like) that may be used in a cold region. The heating device 100 is disposed on the battery pack 200. More specifically, the heating device 100 is disposed such that the principal surface 10b faces the battery pack 200.

In the above description, an example has been illustrated in which the heating device 100 heats the battery pack 200. However, a target heated by the heating device 100 is not limited to the battery pack 200. That is, the heating device 100 is also applicable to other than the storage device 300.

### (Effect of Heating Device According to Embodiment)

Effects of the heating device 100 will be described in the following.

When the temperature of the battery pack 200 is low, it is difficult to charge or discharge the battery pack 200 efficiently. In addition, charging or discharging the battery pack 200 though the temperature of the battery pack 200 is low may cause a degradation of the battery pack 200. Therefore, the battery pack 200 is preferably heated quickly and efficiently.

In the microheater 20, the central portion 22b is disposed on the opening portion 21c by being supported by the connecting portion 22c, and the heater portion 25a is disposed on the central portion 22b. When this is expressed from another viewpoint, the heater portion 25a is suspended in midair in the microheater 20. Therefore, a heat capacity in the vicinity of the heater portion 25a is small, and a time taken for the heater portion 25a to reach a high temperature is short. The heating device 100 can therefore start heating the battery pack 200 quickly.

In the microheater 20, a heat transfer path from the heater portion 25a is localized. The heating device 100 can therefore heat the battery pack 200 efficiently by heat generated in the heater portion 25a.

Further, in the microheater 20, as a result of the localization of the heat transfer path from the heater portion 25a, the temperature of structures surrounding the heater portion 25a (remaining part of the microheater 20, the silicon substrate 30, the board 10, and the like) is not easily raised. The heating device 100 therefore obviates a need for a device for cooling the surrounding structures or a heat insulating material. Thus, the storage device 300 can be miniaturized.

In the heating device 100, the mechanical strength of the microheater 20 can be reinforced by the silicon substrate 30. Thus, durability of the heating device 100 can be improved. In addition, by electrically connecting the microheater 20 and the board 10 to each other by using the conductor 31 and the conductor 32 of the silicon substrate 30, it is possible to reduce a footprint necessary to mount the microheater 20 on the board 10. As a result, intervals between the microheaters 20 adjacent to each other can be decreased, and efficiency of heating the heating target body can be improved.

In the heating device 100, the opening portion 30c is formed in the silicon substrate 30, and the opening portion 10c is formed in the board 10. Therefore, heat from the heater portion 25a is easily transmitted to the battery pack 200 through the opening portion 30c and the opening portion 10c, so that the heating efficiency can be further improved. In addition, the battery pack 200 generates heat while charge or discharge is performed. The heat generated from the battery pack 200 is dissipated through the opening portion 30c, the opening portion 10c, and the opening portion 21c. Thus, the heating device 100 can be prevented from hindering the dissipation of the heat from the battery pack 200.

In the heating device 100, the board 10 is a flexible printed board, and therefore the board 10 easily conforms to the surface of the battery pack 200 due to the flexibility of the flexible printed board. As a result, a distance between the microheater 20 and the battery pack 200 can be shortened, and the heating efficiency can be further improved.

A difference in temperature between parts of the battery pack 200 can be a cause of degradation of the battery pack 200. In the heating device 100, the controller 40 can control each of heating operations of the plurality of microheaters 20 independently, or control the heating operations of the plurality of microheaters 20 for each region of the board 10. The heating device 100 can therefore suppress degradation of the battery pack 200 due to a local difference in temperature of the battery pack 200.

Embodiments of the present disclosure have been described above. However, the foregoing embodiments can be modified in various manners. In addition, the scope of the present disclosure is not limited to the foregoing embodiments. The scope of the present disclosure is indicated by claims, and is intended to include all modifications within meanings and scopes equivalent to claims.

What is claimed is:

1. A heating device comprising:
a board; and
a plurality of microheaters arranged on the board and electrically connected to the board;
the plurality of microheaters being arranged in a form of an array;
each of the plurality of microheaters including a first silicon substrate, an insulating film, and a heater;
a first opening portion that penetrates the first silicon substrate along a thickness direction being formed in the first silicon substrate;
the insulating film including a central portion on which the heater is disposed, a peripheral portion disposed on the first silicon substrate, and a connecting portion that connects the central portion and the peripheral portion to each other, and supports the central portion on the first opening portion.

2. The heating device according to claim 1, further comprising:
a plurality of second silicon substrates, wherein
each of the plurality of second silicon substrates is disposed between each of the plurality of microheaters and the board.

3. The heating device according to claim 2, wherein
a via hole that penetrates each of the plurality of second silicon substrates along the thickness direction is formed in each of the plurality of second silicon substrates, and
each of the plurality of second silicon substrates has a conductor that is disposed within the via hole and electrically connects each of the plurality of microheaters and the board to each other.

4. The heating device according to claim 2, wherein
a second opening portion that penetrates each of the plurality of second silicon substrates along the thickness direction is formed in each of the plurality of second silicon substrates, and
each of the plurality of second silicon substrates is disposed such that the second opening portion is superposed on the first opening portion.

5. The heating device according to claim 4, wherein
a plurality of third opening portions that penetrate the board along the thickness direction are formed in the board, and
the board is disposed such that each of the plurality of third opening portions is superposed on the first opening portion of each of the plurality of microheaters and the second opening portion of each of the plurality of second silicon substrates.

6. The heating device according to claim 1, wherein
the board is a flexible printed board.

7. The heating device according to claim 1, further comprising:
a controller, wherein
the controller is connected to the plurality of microheaters, and configured to be able to control operation of the heater of each of the plurality of microheaters individually.

8. A storage device comprising:
a battery pack; and
the heating device according to claim 1;
the board being disposed on the battery pack.
